(19) United States
(12) Patent Application Publication
(10) Pub. No.: US 2019/0018572 A1
(43) Pub. Date: Jan. 17, 2019

(54) CONTENT ITEM PLAYERS WITH VOICE-OVER ON TOP OF EXISTING MEDIA FUNCTIONALITY

(71) Applicant: Google Inc., Mountain View, CA (US)

(72) Inventors: Shiva Rama Krishna Jaini, Santa Clara, CA (US); Milchie Cao, San Bruno, CA (US)

(21) Appl. No.: 14/595,525

(22) Filed: Jan. 13, 2015

(51) Int. Cl. G06F 3/0484

(52) U.S. Cl. CPC G06F 3/04842

(57) ABSTRACT

A method for providing content item player is disclosed. The method comprises providing, using a processing device, playback of a first content item using a first user interface, wherein the first content item is associated with first video content and first audio content; receiving, using the processing device, a user pertaining to a user performance associated with the first content item; generating second video content and second audio content in response to receiving the user request, wherein the second video content and the second audio content correspond to the user performance associated with the first content item; and providing, using the processing device, playback of the first content item in association with the second video content and the second audio content.

### TECHNICAL FIELD

This disclosure relates to the field of content sharing platforms and, in particular, to a content item player with voice-over on top of existing media functionality (e.g., sing-along songs functionality).

### BACKGROUND

On the Internet, social networks allow users to connect to and share information with each other. Many social networks include a content sharing aspect that allows users to upload, view, and share content, such as video content, image content, audio content, and so on. Other users of the social network may comment on the shared content, discover new content, locate updates, share content, and otherwise interact with the provided content. The shared content may include content from professional content creators, e.g., movie clips, TV clips, and music videos, as well as content from amateur content creators, e.g., video blogging and short original videos.

While consuming a content item (e.g., a video) rendered by a content item player (e.g., a video player on a social network page or social network application on a mobile device), a user may want to perform an audio component of the content item (e.g., a song). Additionally, the user may want to record the user's performance and share the recorded performance with other users. However, options for content item players provided by current content sharing platforms are limited and do not provide users with these features.

### SUMMARY

The following is a simplified summary of the disclosure in order to provide a basic understanding of some aspects of the disclosure. This summary is not an extensive overview of the disclosure. It is intended to neither identify key or critical elements of the disclosure, nor delineate any scope of the particular implementations of the disclosure or any scope of the claims. Its sole purpose is to present some concepts of the disclosure in a simplified form as a prelude to the more detailed description that is presented later.

A method in accordance with some implementations of the disclosure comprises: providing, using a processing device, playback of a first content item using a first user interface, wherein the first content item is associated with first video content and first audio content; receiving, using the processing device, a user request pertaining to a user performance associated with the first content item; generating second video content and second audio content in response to receiving the user request, wherein the second video content and the second audio content correspond to the user performance associated with the first content item; and providing, using the processing device, playback of the first content item in association with the second video content and the second audio content.

In some implementations, the method further comprises: causing the first video content to be presented in a first portion of a second user interface; and causing the second video content to be presented in a second portion of the second user interface.

In some implementations, the method further comprises causing the second audio content to be played in association with the first audio content.

In some implementations, the method further comprises: receiving a user request to record the user performance; recording the second audio content to generate recorded audio content; recording the second video content to generate recorded video content; and generating a second content item based on the recorded audio content and the recorded video content.

In some implementations, the method further comprises receiving a user request to share the second content item with a contact of a user; and causing information related to the second content item to be sent to a computer device associated with the contact of the user.

In some implementations, the method further comprises synchronizing the first content item with the second content item.

In some implementations, the method further comprises: receiving a user request for playback of the second content item; and providing playback of the second content item in synchronization with the first content item.

In some implementations, the method further comprises: causing the first video content to be presented in a first portion of a third user interface; causing the second video content to be presented in a second portion of the third user interface; and causing the first audio content to be played in synchronization with the second audio content.

In some implementations, the method further comprises: receiving a user request to switch from the first content item to the second content item; causing the first video content to be presented in the second portion of the third user interface; and causing the second video content to be presented in the first portion of the third user interface.

In some implementations, the method further comprises: receiving a first indication to dismiss the first portion of the third user interface; and dismissing the playback of the first audio content in response to receiving the first indication.

In some implementations, the method further comprises: receiving a second indication to dismiss the second portion of the third user interface; and dismissing the playback of the second audio content in response in response to receiving the second indication.

### BRIEF DESCRIPTION OF THE DRAWINGS

The present disclosure is illustrated by way of example, and not by way of limitation, in the figures of the accompanying drawings.

FIG. 1 illustrates an example of a system architecture for providing a content item player with voice-over on top of existing media functionality, in accordance with one implementation of the disclosure.

FIG. 2 is a block diagram illustrating a media viewer and content item player components in accordance with one implementation of the disclosure.

FIG. 3 is a flow diagram illustrating a method for providing a content item player with voice-over on top of existing media functionality by a client device, according to some implementations of the disclosure.

FIG. 4 is a flow diagram illustrating a method for providing a content item player with voice-over on top of existing media functionality by a server device, according to some implementations of the disclosure.

FIG. 5 is a flow diagram illustrating a method for providing playback of a user-generated content item and a source content item by a client device, according to some implementations of the disclosure.

FIG. 6 is a flow diagram illustrating a method for providing playback of a user-generated content item and a source content item by a server device, according to some implementations of the disclosure.

FIGS. 7A and 7B are examples of user interfaces for providing playback of a source media content item according to some implementations of the disclosure.

FIG. 8 is an example of a user interface for providing a content item player with voice-over on top of existing media functionality according to some implementations of the disclosure.

FIG. 9 is an example of a user interface for providing a content item player with voice-over on top of existing media functionality according to another implementation of the disclosure.

FIG. 10 is an example of a user interface for sharing user generated content items according to some implementations of the disclosure.

FIG. 11 is an example of a user interface for providing playback of a user generated content item in association with a source content item according to some implementations of the disclosure.

FIG. 12 is a block diagram illustrating an exemplary computer system, according to some implementations.

### DETAILED DESCRIPTION

Implementations are described for a content item player of a content sharing platform. In implementations of the disclosure, a content item player with voice-over on top of existing media functionality (e.g., sing-along songs functionality) is provided.

Implementations of the disclosure have a different layer of granularity than previous solutions for providing content item players for content sharing platforms. While providing playback of a content item (e.g., a video) hosted by a content sharing platform (also referred to herein as the “source content item”), implementations of the disclosure may provide a content item player having voice-over on top of existing media functionality (e.g., sing-along songs functionality). As used herein, the term “voice-over on top of existing media” refers to a user activity that involves a user attempt to perform an audio component of a content item that is being played concurrently with the user performance. For example, the content item player can prompt a user for voice performance associated with the content item (e.g., to sing along while a song in the content item is being played, or to give any other voice performance (e.g., a presentation's speech, a movie's voice part, etc.) on top of the audio component of the content item being played). In response to receiving a user request pertaining to the voice performance, the content item player may provide playback of the source content item in association with audio content and/or video content corresponding to the user performance. For example, the content item player may provide playback of video content associated with the content item and video content corresponding to the user's performance in multiple portions of a user interface. As another example, the content item player may cause audio content associated with the content item to be played along with audio content corresponding to the user's performance. Additionally, the content item player may record the video content and/or the audio content corresponding to the user's performance.

Implementations of the disclosure may also provide the user with content sharing functions. For example, implementations of the disclosure may generate a content item corresponding to the user performance (e.g., also referred to herein as the “user-generated content item”) and enable the user to share the user-generated content item with one or more other users.

Implementations of the disclosure may further provide playback of the user-generated content item in synchronization with the source content item. For example, implementations of the disclosure may present video content associated with the user-generated content item and video content associated with the source content item in multiple portions of a user interface. As another example, implementations of the disclosure may present audio content associated with the user-generated content item in synchronization with audio content associated with the source content item.

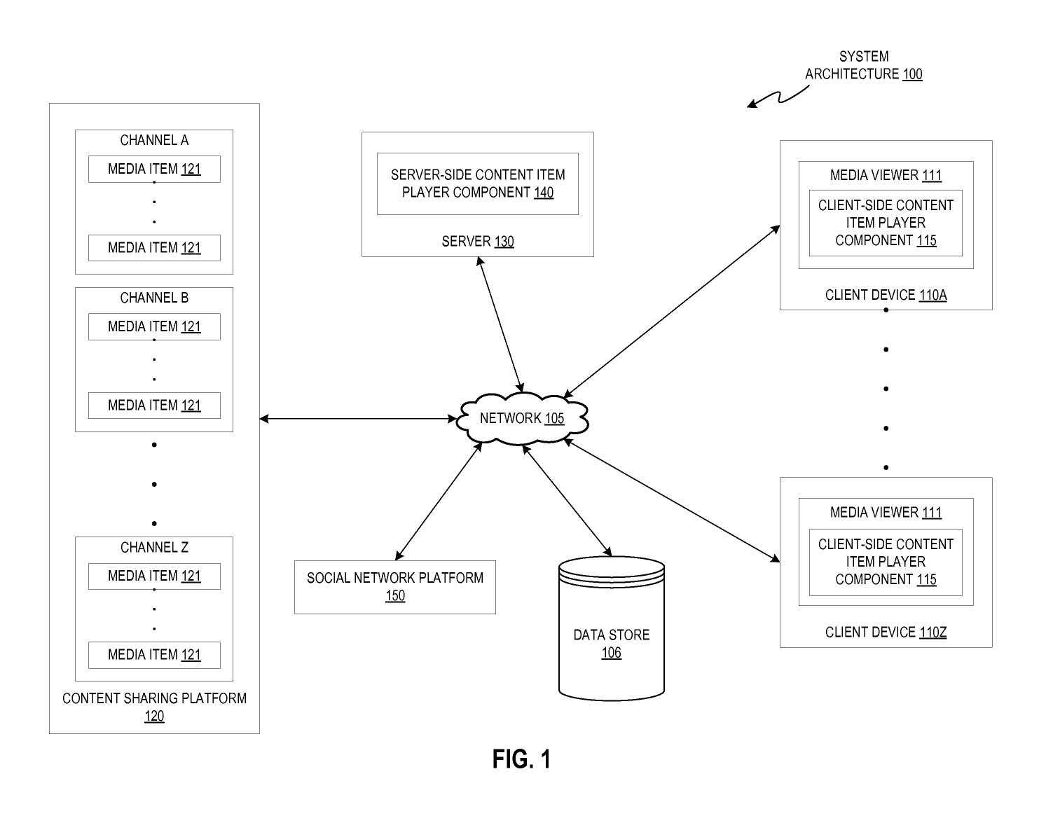

FIG. 1 illustrates an example of a system architecture 100, in accordance with one implementation of the disclosure, for providing a media content item player with sing-along songs functionality. The system architecture 100 includes client devices 110A through 110Z, a network 105, a data store 106, a content sharing platform 120, and a server 130. In one implementation, network 105 may include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof. In one implementation, the data store 106 may be a memory (e.g., random access memory), a cache, a drive (e.g., a hard drive), a flash drive, a database system, or another type of component or device capable of storing data. The data store 106 may also include multiple storage components (e.g., multiple drives or multiple databases) that may also span multiple computing devices (e.g., multiple server computers).

The client devices 110A through 110Z may each include computing devices such as personal computers (PCs), laptops, mobile phones, smart phones, tablet computers, netbook computers etc. In some implementations, client device 110A through 110Z may also be referred to as “user devices.” Each client device includes a media viewer 111. In one implementation, the media viewers 111 may be applications that allow users to view content, such as images, videos, web pages, documents, etc. For example, the media viewer 111 may be a web browser that can access, retrieve, present, and/or navigate content (e.g., web pages such as Hyper Text Markup Language (HTML) pages, digital media items, etc.) served by a web server. The media viewer 111 may render, display, and/or present the content (e.g., a Web page, video content, audio content, text, etc.) to a user. The media viewer 111 may also display an embedded media player (e.g., a Flash® player or an HTML5 player) that is embedded in a web page (e.g., a web page that may provide information about a product sold by an online merchant). In another example, the media viewer 111 may be a standalone application that allows users to view digital media items (e.g., digital videos, digital images, electronic books, etc.).

The media viewers 111 may be provided to the client devices 110A through 110Z by the server 130 and/or content sharing platform 120. For example, the media viewers 111 may be embedded media players that are embedded in web pages provided by the content sharing platform 120. In another example, the media viewers 111 may be applications that are downloaded from the server 130.

In general, functions described in one implementation as being performed by the content sharing platform 120 can also be performed on the client devices 110A through 110Z in other implementations if appropriate. In addition, the functionality attributed to a particular component can be performed by different or multiple components operating together. The content sharing platform 120 can also be accessed as a service provided to other systems or devices through appropriate application programming interfaces, and thus is not limited to use in websites.

In one implementation, the content sharing platform 120 may be one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that may be used to provide a user with access to media items and/or provide the media items to the user. For example, the content sharing platform 120 may allow a user to consumer, upload, search for, approve of (“like”), dislike, and/or comment on media items. The content sharing platform 120 may also include a website (e.g., a webpage) that may be used to provide a user with access to the media items. Content sharing platform 120 may include any type of content delivery network providing access to content and/or media items.

The content sharing platform 120 may include multiple channels (e.g., channels A through Z). A channel can be data content available from a common source or data content having a common topic or theme. The data content can be digital content chosen by a user, digital content made available by a user, digital content uploaded by a user, digital content chosen by a content provider, digital content chosen by a broadcaster, etc. For example, a channel X can include videos Y and Z. A channel can be associated with an owner, who is a user that can perform actions on the channel. Different activities can be associated with the channel based on the owner's actions, such as the owner making digital content available on the channel, the owner selecting (e.g., liking) digital content associated with another channel, the owner commenting on digital content associated with another channel, etc. The activities associated with the channel can be collected into an activity feed for the channel. Users, other than the owner of the channel, can subscribe to one or more channels in which they are interested. Once a user subscribes to a channel, the user can be presented with information from the channel's activity feed. If a user subscribes to multiple channels, the activity feed for each channel to which the user is subscribed can be combined into a syndicated activity feed. Information from the syndicated activity feed can be presented to the user. Although channels are described as one implementation of a content sharing platform, implementations of the disclosure are not limited to content sharing platforms that provide content items via a channel model.

Each channel may include one or more content items 121. Examples of a content item 121 can include, and are not limited to, digital video, digital movies, digital photos, digital music, website content, social media updates, electronic books (ebooks), electronic magazines, digital newspapers, digital audio books, electronic journals, web blogs, real simple syndication (RSS) feeds, electronic comic books, software applications, etc. In some implementations, content item 121 is also referred to as a media item.

A content item 121 may be consumed via the Internet and/or via a mobile device application. For brevity and simplicity, an online video (also hereinafter referred to as a video) is used as an example of a content item 121 throughout this document. As used herein, “media,” media item,” “online media item,” “digital media,” “digital media item,” “content,” and “content item” can include an electronic file that can be executed or loaded using software, firmware or hardware configured to present the digital content item to an entity. In one implementation, the content sharing platform 120 may store the content items 121 using the data store 106.

The social network platform 150 may be and/or include one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that may be used to provide a user with content sharing services. For example, as will be described in more detail further below in accordance with some implementations, the social network platform 150 may enable a user to share one or more content items corresponding to the user performance with other users.

In one implementation, the server 130 may be one or more computing devices (e.g., a rackmount server, a server computer, etc.). In one implementation, the server 130 may be included in the content sharing platform 120 and/or a social network platform 150. The server 130 may include a server-side content item player component 140. The media viewer 111 at the client device 110A-110Z includes a client-side content item player component 115. The content item player components 115, 140 may operate together to provide a content item player viewable at the client device 110A-110Z. In other implementations, one or the other of the content item player component 115, 140 may individually be responsible for providing content item players viewable at the client device 110A-110Z. More specifically, in some implementations of the disclosure, the content item player components 115, 140 may cause the content item players at the media viewer to provide playback of a content item 121 of the content sharing platform 120. During the playback of the content item 121, the content item player components 115, 140 may provide a user with voice-over on top of existing media functionality (e.g., sing-along songs functionality).

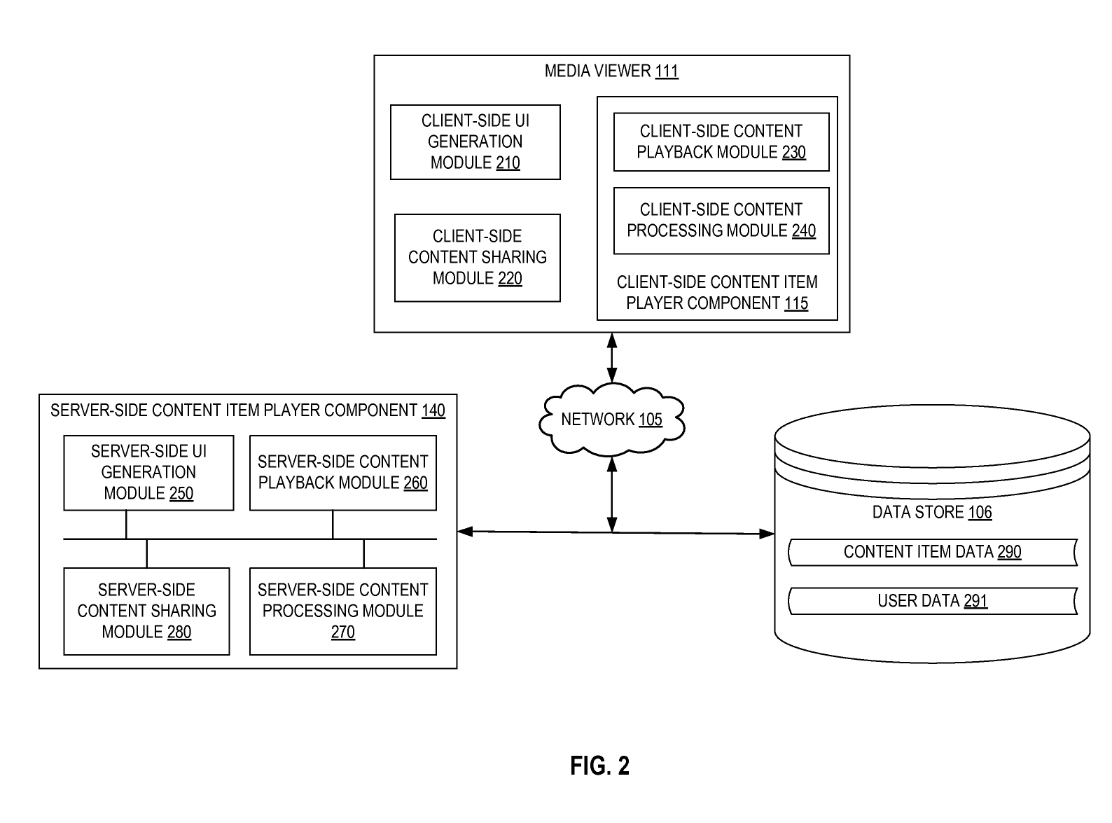

Further description of the content item player components 115, 140 and their specific functions is provided in more detail below with respect to FIG. 2.

Although implementations of the disclosure are discussed in terms of content sharing platforms and promoting social network sharing of a content item on the content sharing platform, implementations may also be generally applied to any type of social network providing connections between users or to any type of content delivery platform providing content to end users. Implementations of the disclosure are not limited to content sharing platforms that provide channel subscriptions to users.

In situations in which the systems discussed here collect personal information about users, or may make use of personal information, the users may be provided with an opportunity to control whether the content sharing platform 120, the server 130, and/or the social network platform 150 collects user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by the content sharing platform 120.

FIG. 2 is a block diagram illustrating a media viewer 111 and a server-side content item player component 140 in accordance with one implementation of the disclosure. The media viewer 111 may be part of a client device, such as client device 110a-110Z of FIG. 1. The media viewer 111 may include a client-side user interface (UI) generation module 210, a client-side content sharing module 220, and a client-side content item player component 115. In one implementation, the client-side content item player component 115 is the same as its counterpart described with respect to FIG. 1. Client-side content item player component 115 may include a client-side content item playback module 230 and a client-side content processing module 240. More or less components may be included in the media viewer 111 and/or the client-side content item player component 115 without loss of generality. For example, two of the modules may be combined into a single module, or one of the modules may be divided into two or more modules.

In one implementation, the server-side content item player component 140 includes a server-side UI generation module 250, a server-side content playback module 260, a server-side content processing module 270, and a server-side content sharing module 280. More or less components may be included in the server-side content item player component 140 without loss of generality. For example, two of the modules may be combined into a single module, or one of the modules may be divided into two or more modules. In one implementation, one or more of the modules may reside on different computing devices (e.g., different server computers).

The server-side content item player component 140 and the media viewer 111 may be communicatively coupled to each other and to the data store 106. For example, the server-side content item player component 140 and the media viewer 111 may be coupled to each other and the data store 106 via a network (e.g., via network 105 as illustrated in FIG. 1). In another example, the server-side content item player component 140 may be coupled directly to a server where the server-side content item player component 140 resides (e.g., may be directly coupled to server 130).

The data store 106 may be a memory (e.g., random access memory), a cache, a drive (e.g., a hard drive), a flash drive, a database system, or another type of component or device capable of storing data. The data store 106 may also include multiple storage components (e.g., multiple drives or multiple databases) that may also span multiple computing devices (e.g., multiple server computers). The data store 106 includes content item data 290, user data 291, and/or any other data that can be used to provide content item players.

As discussed above, one or both of client-side and/or server-side content item player components 115, 140 cause a content item player in media viewer 111 to play content items of the content sharing platform with voice-over on top of existing media functionality (e.g., sing-along songs functionality). In one implementation, client-side UI generation module 250 provides a UI for the content sharing platform to present to a user via media viewer 111. The UI may include menus and interfaces for the user to interact with the content sharing platform via media viewer 111. For example, the menus and interfaces may include a suggestions interface of what to watch next, a search interface for content items of the content sharing platform, a browsing interface for content items of the content sharing platform, a settings interface, a subscriptions interface, a playlists interface, a favorites interface, a history interface, an uploads interface, and so on. When the user selects a content item to view via one of the menus or interfaces, or when the media viewer is initially opened as a result of the user's selection of a content item in a different application on the client device than the media viewer 111, the client-side UI generation module 210 may present a content item player for playback of the selected content item.

In some implementations, the server-side content item player component 140 cooperates with the client-side UI generation module 210 to present the content item player. The server-side content item player generation module 210 sends data pertaining to the content item player to the media viewer 111. In some implementations, the server-side content item player generation module 210 may interact with the server-side UI generation module 220 to determine a video format (e.g., a display resolution, a coding format, etc.) and other client-device specific features for the content item player to be displayed in the content sharing platform UI of the media viewer 111. The media viewer 111 may then display the UI and content item player based on the received data from server-side content item player component 140.

The content item data 290 related to the selected content item (e.g., the source content item) may include any suitable data that can be used to provide playback of the source content item. For example, the content item data 290 may include video data that can be used to provide playback of video content associated with the source content item (also referred to herein as the “source video content”). In a more particular example, the video data can include one or more encoded video frames associated with the source video content, decoding parameters associated with the encoded video frames, presentation timestamps associated with the encoded video frames, etc.

As another example, the content item data 290 may include audio data that can be used to provide playback of audio content associated with the source content item (also referred to herein as the “source audio content”). In some implementations, the source audio content corresponds to an audio component of the source content item (e.g., a song, a speech, a movie's voice part, etc.). For example, the source audio content may include audio content corresponding to one or more vocal tracks of the audio component and/or audio content corresponding to instrumental music of the song, speech, or any other audio component of the source content item.

As yet another example, the content item data 290 may include captioning data related to the source content item, such as data about lyrics of the music item associated with the source content item, programming information related to the source content item (e.g., a title, a description, etc. of the source content item), etc.

The user data 291 can include information related to one or more users of content sharing platform 120. For example, the user data 291 may include identifying information related to the users, such as user identifiers associated with the users. As another example, the user data 291 may include information indicating that a given user is a minor (e.g., a user younger than 18) and identifying information related to one or more users associated with the minor (e.g., a user that is a parent of the minor user). As yet another example, the user data 291 may include information related to one or more other users associated with a given user, such as one or more social connections of the given user. Examples of a social connection of the user include a “friend,” a “follower,” a “subscriber,” a “connection,” a “contact,” and/or any other user that is connected to the user via the content sharing platform 120, the social network platform 150, an email service, a phone service, and/or any other platform or service.

Client-side UI generation module 210 may receive the content item data 290 and/or user data 291 from content sharing platform. For example, client-side UI generation module 210 may receive data 290 and/or data 291 in response to receiving a user selection of the source content item for playback via a menu or interface of the media viewer 111. In some implementations, content item data 290 is streamed to the media viewer 111 by the content sharing platform 120 for playback by the media viewer 111 to the user.

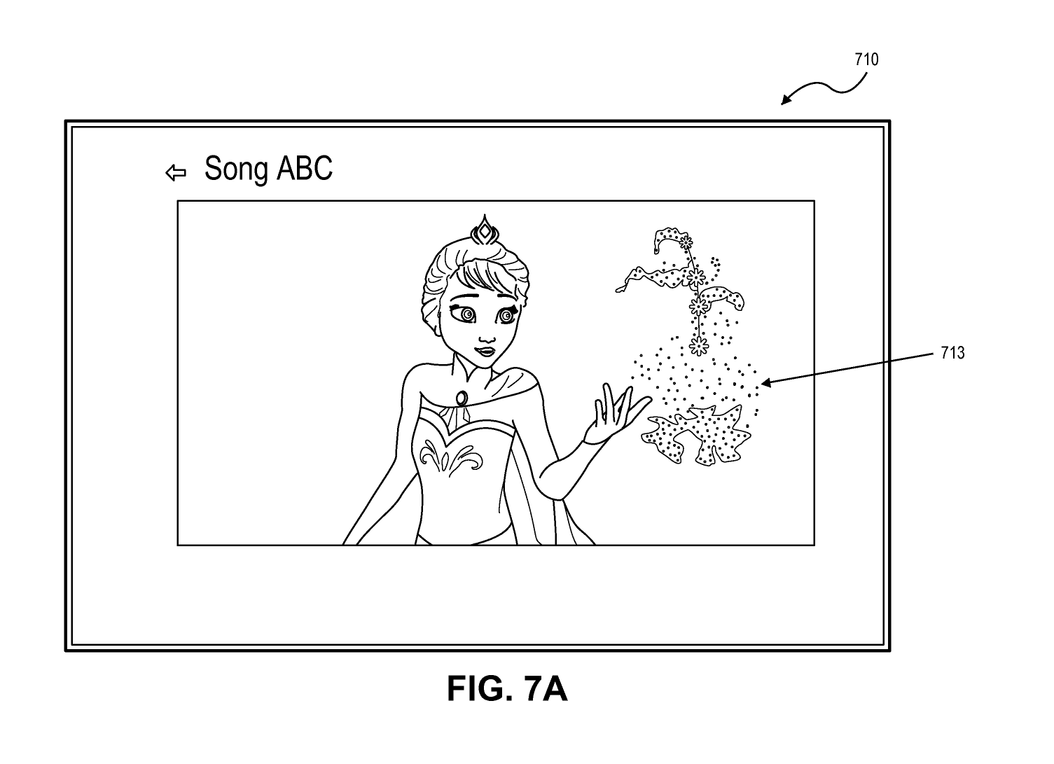

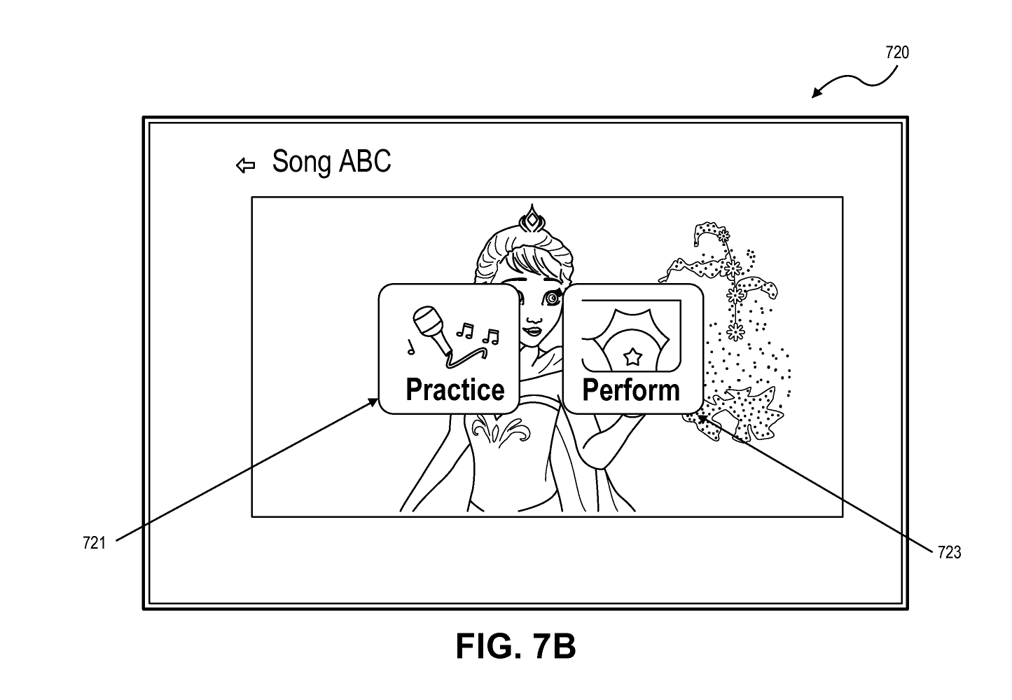

In one implementation, the client-side UI generation module 210 may pass the received data 290, 291 onto client-side content item player component 115 to facilitate playback of the source content item at media viewer 111. For example, the client-side content playback module 230 may present the source video content using a user interface 710 as shown in FIG. 7A. As illustrated, the user interface 710 includes a content item player 713 for playback of the source video content. As another example, the client-side content playback module 230 may cause the source audio content to be played by an audio output device (e.g., a speaker). The source audio content can include, for example, audio content that can correspond to one or more vocal tracks and instrumental music associated with the source content item.

The media viewer 111 can prompt a user for a voice performance associated with the source content item. For example, the media viewer 111 may present a user interface 720 as shown in FIG. 7B on the client device to prompt the user to perform the music item. As illustrated in FIG. 7B, the user interface 720 may include a “practice” button 721, a “perform” button 723, and/or any other suitable component to provide sing-along songs functionality.

The media viewer 111 may receive a user request pertaining to the voice performance via any suitable user input. In one example, the user request corresponds to a user selection of one or more of the “practice” button 721 and the “perform” button 723 (e.g., by tapping, clicking, and/or performing any other action on the button 721 or 723). In another example, the user request corresponds to a voice command and/or a user gesture indicative of a user request pertaining to the voice performance.

In response to receiving a user request pertaining to the voice performance associated with the content item, the media viewer 111 may provide one or more content item players having voice-over on top of existing media functionality (e.g., sing-along songs functionality). For example, the client-side content playback module 230 provides playback of the source audio content in association with user-generated audio content corresponding to the user performance (e.g., the voice performance) associated with the source content item. The user-generated audio content may be generated using an audio input device (e.g., a microphone). In a more particular example, the client-side content playback module 230 may cause the source audio content to be played along with the user generated audio content via an audio output device (e.g., a speaker). The source audio content includes audio content corresponding to the instrumental music of the music item without one or more of the vocal tracks (e.g., one or more lead vocals). Alternatively, the source audio content includes audio content corresponding to the instrumental music and the vocal tracks. In some implementations, the user-generated audio content and the source audio content can be played at different volume levels.

As another example, the media viewer 111 provides playback of the source video content in association with user-generated video content. In one implementation, the user-generated video content may be generated using a video input device (e.g., a camera, a camcorder, etc.) and may correspond to the user performance. In another implementation, the user-generated video content may correspond to any other video content designated by the user, such as one or more still images, content items stored in a local storage device, content items provided by the content sharing platform 120 and/or any other suitable source, etc.

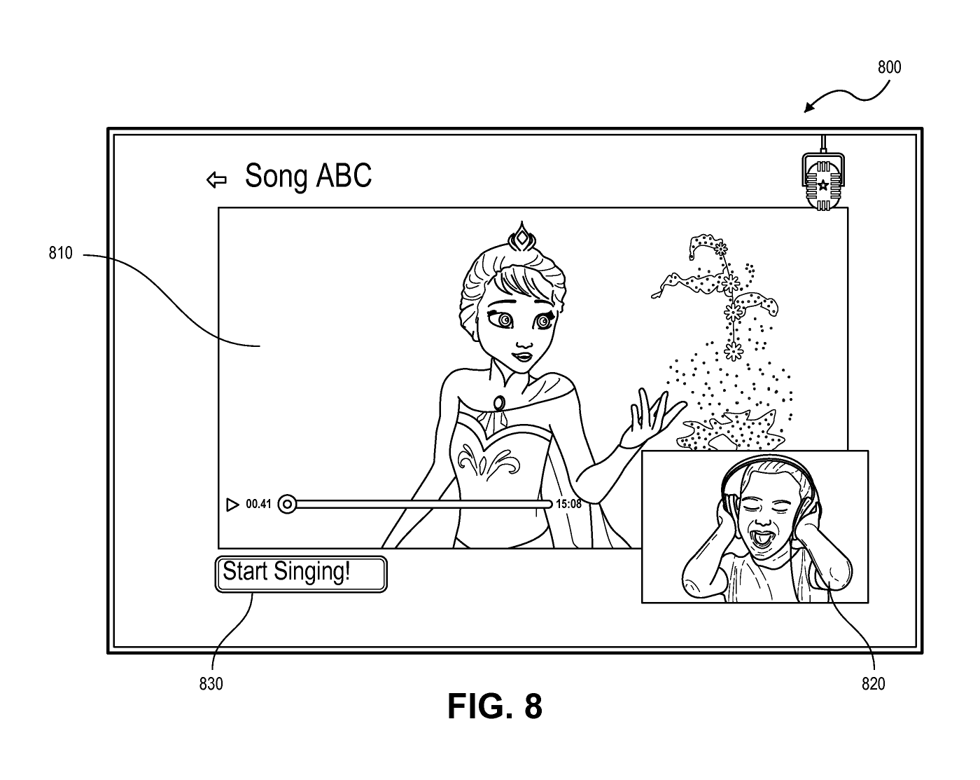

The client-side content playback module 230 may provide playback of the user-generated video content and the source video content in multiple portions of a user interface. In a more particular example, as shown in FIG. 8, a user interface 800 can be generated and presented for playback of the source video content and the user-generated video content. As illustrated, the source video content and the user generated video content can be presented in a content item player 810 and a content item player 820, respectively. Each of the content item player 810 and the content item player 820 can be implemented in a variety of sizes and is not limited to a specific position within the user interface 800. In one implementation, one or more portions of the content item player 820 overlap the content item player 810. In another implementation, the content item player 810 and the content item player 820 do not overlap each other. The content item player 810, 820 may also be moved (e.g., dragged) within the user interface 800 to suit the user's preferences.

In some implementations of the disclosure, the media viewer 111 receives a user request to record a performance of the music item. In one example, the user request may correspond to a user selection of the “perform” button 723 of FIG. 7B and/or the “start singing” button 830 of FIG. 8. In another example, the user request may correspond to a user gesture, a voice command, and/or any other user input. In response to receiving the user request, the client-side content processing module 240 records the user-generated audio content to generate recorded audio content. Additionally or alternatively, the client-side content processing module 240 records the user-generated video content to generated recorded video content.

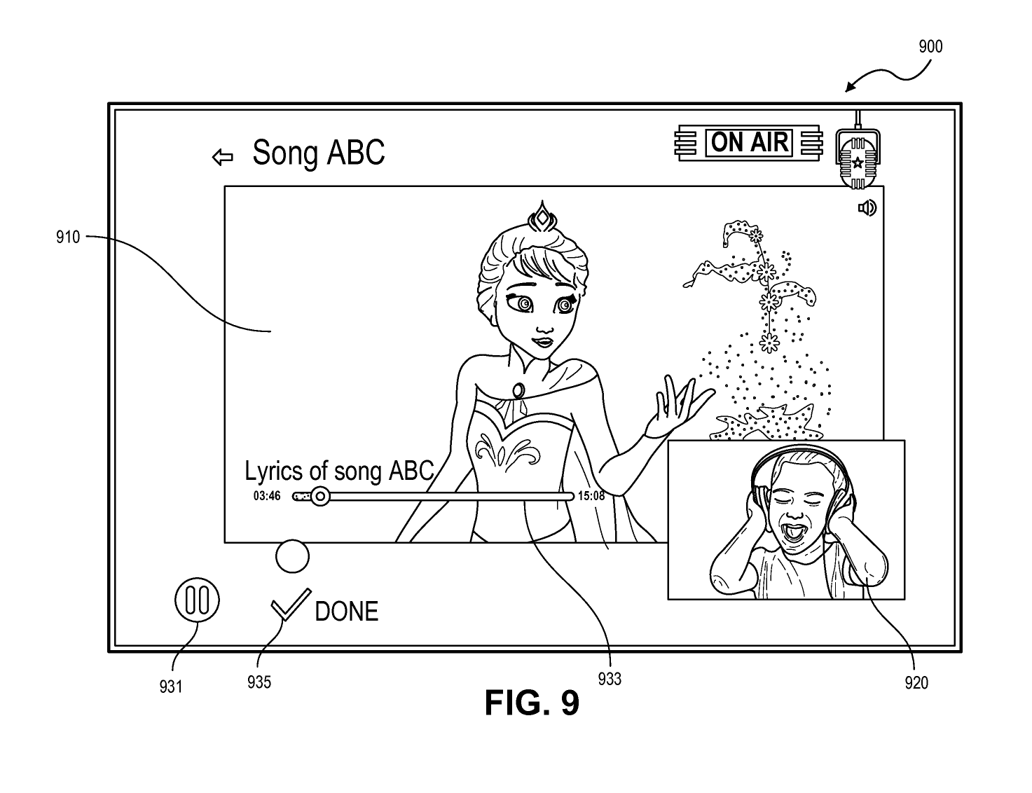

Additionally, the media viewer 111 may present one or more user interfaces to provide sing-along songs functionality to the user. For example, the media viewer 111 may present a user interface 900 as shown in FIG. 9 in some implementations. As illustrated, the user interface 900 includes a content item player 910 and a content item player 920 for presenting the source video content and the user-generated video content. In some implementations, the source video content and the user-generated video content may be presented in association with information related to the source content item, such as a title or description of the source content item and/or the music item, lyrics of the music item, etc.

The user interface 900 may further include one or more interface elements for controlling the playback of the source content item and/or recording of the user-generated video content and/or audio content. For example, the user interface 900 includes a “pause” button 931, a playback control component 933, and an indicator 935. In some implementations, a user of the media viewer 111 may control the playback of the source content item using the playback control component 933 (e.g., rewinding, forwarding, pausing, etc. the playback of the source content item) and perform the music item associated with one or more portions of the source content item (e.g., by dragging or clicking the playback controller 933 to skip a segment of the source content item).

In response to receiving a user request to generate a content item (e.g., a user selection of the indicator 935, a voice command, a user gesture, etc.), the client-side content processing module 240 may generate one or more content items (also referred to herein as “user-generated content items”) based on the recorded audio content and/or the recorded video content. Alternatively or additionally, the client-side content item player component 115 may transmit the recorded audio content, the recorded video content, and/or the user-generated content item(s) to the server-side content item player component 140 for processing and/or storage.

The user-generated content items may be generated by the client-side content processing module 240 and/or the server-side content processing module 270. For example, the client-side content processing module 240 and/or the server-side content processing module 270 can synchronize the recorded audio content and the recorded video content to generate a user-generated content item. As another example, the client-side content processing module 240 and/or the server-side content processing module 270 can generate mixed audio content by mixing the recorded audio content and one or more portions of the source audio content (e.g., the source audio content corresponding to the instrumental music of the music item). The client-side content processing module 240 and/or the server-side content processing module 270 can then synchronize the mixed audio content and the recorded video content to generate a user-generated content item. Additionally, the client-side content processing module 240 and/or the server-side content processing module 270 may synchronize the user-generated content item with the source content item. More particularly, for example, the client-side content processing module 240 and/or the server-side content processing module 270 may associate presentation timestamps with portions of the user-generated content item and corresponding portions of the source content item.

The server-side content processing module 270 may associate the user-generated content item with the source content item. For example, the server-side content processing module associate an identifier (e.g., a URL, a description, etc.) with the user-generated content item and the source content item. Additionally, the server-side content processing module 270 may store information related to the user-generated content item and information related to the source content item in association with the identifier in the data store 106 or any other data storage device. Information related to the user-generated content item may include identifying information related to the user-generated content item (e.g., a URL, a video identifier, a title, etc.), the user-generated video content, the user-generated audio content, the mixed audio content, presentation timestamps for use in playback of the user-generated content item in synchronization with the source content item, etc.

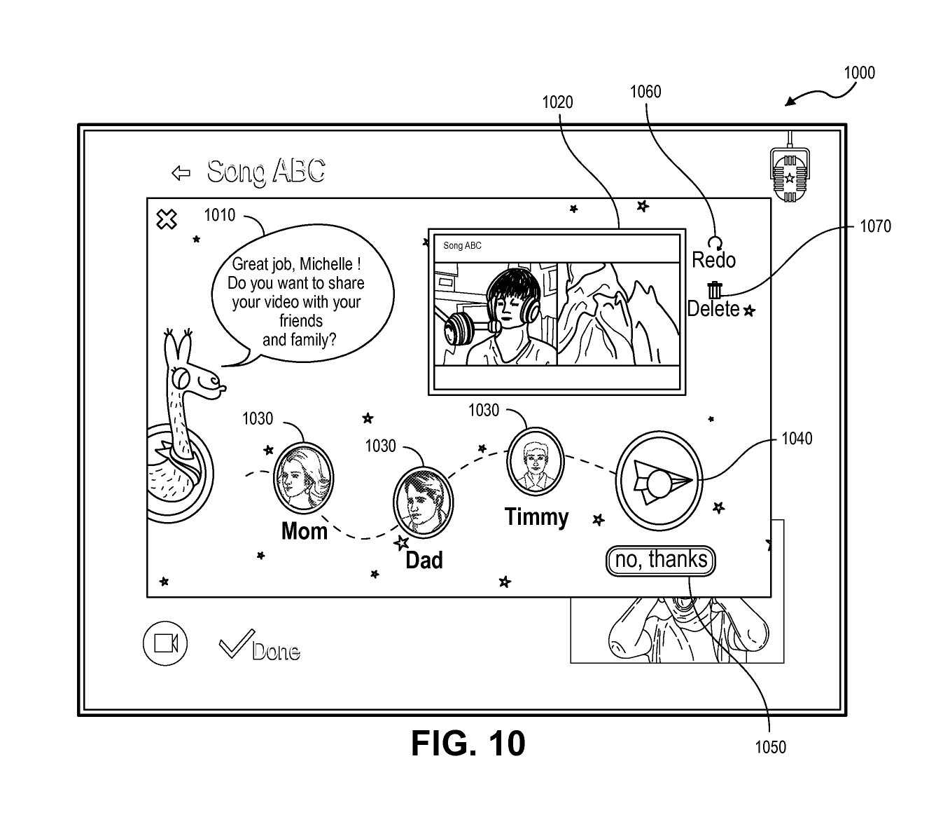

In some implementations, the media viewer 111 may prompt the user to share the user-generated content item with one or more other users by presenting one or more user interfaces to the user. For example, the client-side UI generation module 210 may present a user interface 1000 as shown in FIG. 10. As illustrated in FIG. 10, the user interface 1000 may include a message 1010 that prompts the user to share the user-generated content item with one or more other users, such as one or more social connections of the user. Additionally, the user interface 1000 includes information related to the user-generated content item and/or the source content item, such as an image 1020.

The user interface 1000 may also include information related to one or more social connections of the user. Examples of a social connection of the user include a “friend,” a “follower,” a “subscriber,” a “connection,” a “contact,” and/or any other user that is connected to the user via the content sharing platform 120, the social network platform 150, an email service, a phone service, and/or any other platform or service. In one implementation, the user interface 1000 may include images (e.g., thumbnail photos) 1030 corresponding to one or more social connections of the user. The user may select one or more of the social connections as recipients of the user-generated content item (e.g., by selecting the images 1030 corresponding to the users).

The user may initiate sharing of the user-generated content item and/or the source content item with the selected social connections by selecting a share button 1040. The sharing can be cancelled in response to receiving a user selection of a cancel button 1050 of the user interface 1000. The user may delete the user-generated content item by selecting a “delete” button 1070. The user may initiate a user request to perform the music item by selecting a “redo” button 1060 of the user interface 1000. In some implementations in which the user is a minor user, a permission to share the user-generated content may be requested from another user, such as a parent of the minor user.

In some implementations, in response to receiving a user selection of one or more of the social connections, client-side content sharing module 220 can send a request to share the user-generated content item to the server-side content sharing module 280. The request can include any suitable identifying information related to the selected social connections, such as a user identifier associated with each of the selected social connections. The request can also include any suitable information related to the user-generated content item, such as audio content associated with the user-generated content item (e.g., the recorded audio content, the mixed audio content, etc.), video content associated with the user-generated content item (e.g., the recorded video content), identifying information related to the user-generated content item (e.g., a video identifier, a description, etc.), identifying information related to the source video content, etc.

Upon receiving the user request to share the user-generated content item, the server-side content sharing module 280 can send a message to the selected social connections of the user. The message can include any suitable information related to the user-generated content item. For example, the message can include a link (e.g., a uniform resource locator (URL)) directed to the user-generated content item and/or the source content item. As another example, the message can include an image related to the user-generated content item and/or the source content-item (e.g., the image 1020 and/or any other suitable image). The message and its associated content can be sent to the selected social connections by email, text messages, mobile notifications, account notifications, etc.

Additionally or alternatively, the server-side content sharing module 280 may post information related to the user-generated content item on the content sharing platform 120, the social network platform 150, and/or any other platform that provides content sharing services. In one implementation, the posted information may be accessible by the selected social connections of the user.

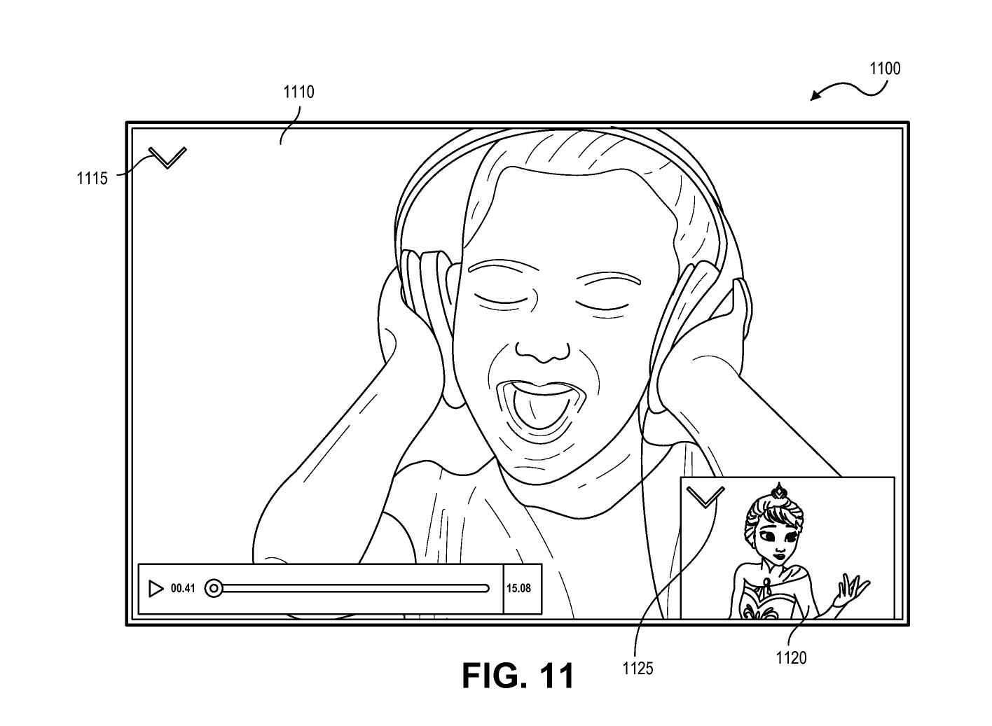

In some implementations, the user and/or the recipients of the message may request playback of the user-generated item (e.g., by clicking the link directed to the user-generated content item). In response to receiving a user request for playback of the user-generated content item, the client-side content playback module 230 may provide playback of the user-generated content item in synchronization with the source content item. For example, the client-side content playback module 230 may provide playback of the recorded video content and the source video content in multiple portions of a user interface. In a more particular example, as shown in FIG. 11, the client-side content playback module 230 may cause the source video content and the recorded video content to be presented in content item players 1110 and 1120 of a user interface 1100, respectively. As another example, the client-side content playback module 230 may cause audio content associated with the user-generated content item (e.g., the recorded audio content, the mixed audio content, etc.) to be played. In some implementations, the audio content associated with the user-generated content item may be played in synchronization with the source audio content.

During the playback of the user-generated content item in synchronization with the source content item, the media viewer 111 may determine whether an indication to switch from the recorded content item to the source content item has been received. In one example, the indication corresponds to a user selection of the user-generated content item or the source content item using the user interface 1100. More particularly, for example, the user may make such a selection by tapping, clicking, dragging, and/or performing any other suitable action on a portion of the user interface 1100 (e.g., a portion the content item player 1110, a portion of the content item player 1120, and/or any other portion of the user interface 1100). In another example, the indication corresponds to a voice command and/or any other user input indicative of a user request to switch from the source content item to the user-generated content item.

In response to receiving the indication to switch from the user-generated content item to the source content item, the client-side content playback module 230 may present the source video content and the recorded video content in the content item players 1110 and 1120, respectively. Additionally, the client-side content playback module 230 may cause the source audio content to be played at a higher volume level. Alternatively, the client-side playback module 230 may dismiss the playback of the recorded audio content.

In some implementations, the client-side content playback module 230 may receive a subsequent indication to switch from the user-generated content item to the source content item (e.g., taps, clicks, etc.). The client-side content playback module 230 may then switch to playback of the user-generated content item. More particularly, for example, the client-side content playback module 230 may provide playback of the user-generated video content and the source video content in the content item players 1110 and 1120 of the user interface 1100, respectively. The client-side content playback module 230 may also increase the volume level at which the audio content associated with the user-generated content item is played. Additionally or alternatively, the client-side content playback module 230 may dismiss the playback of the source audio content and/or reduce the volume level at which the source audio content is played.

During the playback of the recorded content item in synchronization with the source content item, the media viewer 111 may determine whether an indication to dismiss and/or minimize the content item player 1110 or the content item player 1120 has been received. In one example, the indication corresponds to a user selection of a minimization indicator 1115 or a minimization indicator 1125 of the user interface 1100. In another example, the indication corresponds to one or more user gestures indicative of a user request to dismiss the content item player 1110 or 1120, such as dragging the content item player 1110 or 1120, swiping left or right on the content item player 1110 or 1120, etc.

In response to receiving an indication to dismiss and/or minimize the content item player 1110, the client-side content playback module 230 dismisses and/or minimizes the content item player 1110. Additionally, the client-side content playback module 230 may maximize the content item player 1120 for playback of the source video content. In some implementations, the maximized content item player may encompass the entire user interface of the media viewer 111.

The client-side content playback module 230 may also dismiss the playback of the audio content associated with the user-generated content item (e.g., the mixed audio content generated based on the recoded audio content and the source audio content, the recorded audio content, etc.). Alternatively or additionally, the client-side content playback module 230 may adjust the volume levels at which the source audio content and the audio content associated with the user-generated content item content (e.g., audio content including vocal tracks of the music item) are played (e.g., by increasing the volume level at which the source audio content is played).

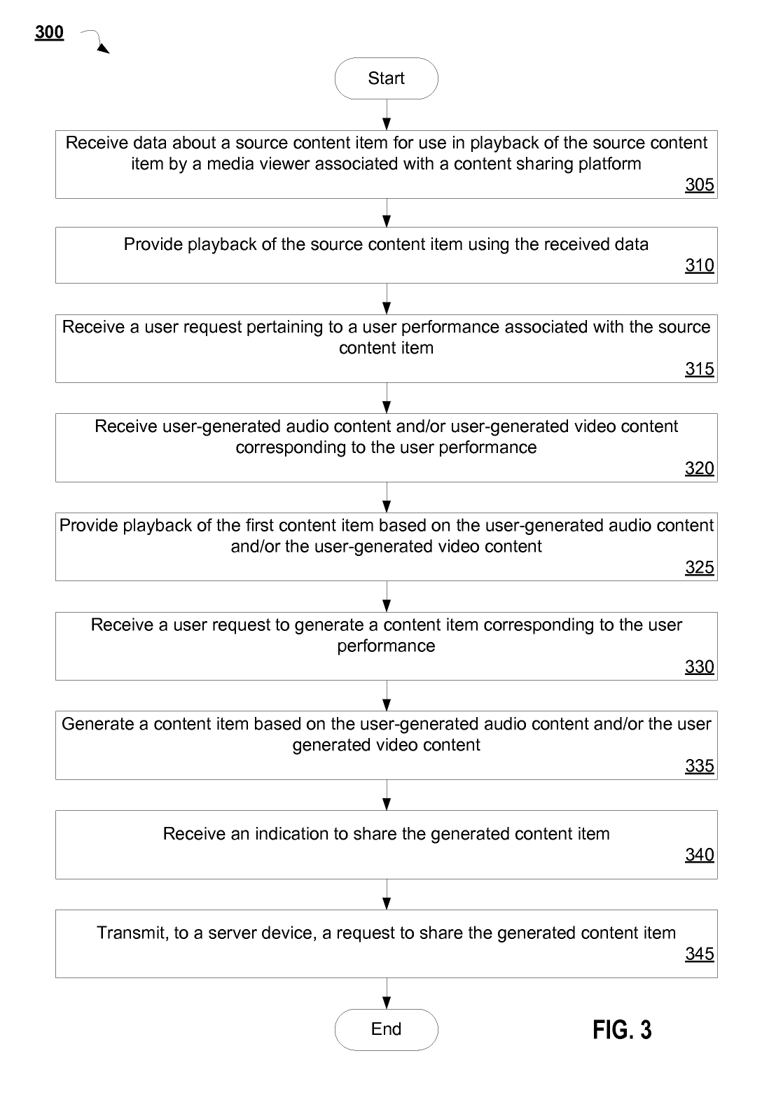

FIG. 3 is a flow diagram illustrating a method 300 for providing a content item player with voice-over on top of existing media functionality by a client device according to some implementations of the disclosure. The method 300 may be performed by processing logic that comprises hardware (e.g., circuitry, dedicated logic, programmable logic, microcode, etc.), software (e.g., instructions run on a processing device to perform hardware simulation), or a combination thereof.

For simplicity of explanation, the methods of this disclosure are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term “article of manufacture,” as used herein, is intended to encompass a computer program accessible from any computer-readable device or storage media. In one implementation, method 300 may be performed by the media viewer 111 as shown in FIGS. 1 and 2.

Method 300 begins at block 305 when the processing device receives data of a source content item for use in playback of the source content item by a media viewer associated with a content sharing platform. The data may include video data associated with the source content item, audio data associated with the source content item, captioning data associated with the source content item, etc. In some implementations, the source content item corresponds to one or more music items, such as a song, a speech, etc.

At block 310, the processing device may provide playback of the source content item using the received data. For example, the processing device may provide playback of video content associated with the source content item using the user interface 710 as shown in FIG. 7A. Additionally, the processing device may provide playback of audio content associated with the source content item using an audio output device (e.g., a speaker). The audio content associated with the source content item may include one or more vocal tracks and/or instrumental music of the music item(s).

At block 315, the processing device can receive a user request pertaining to a user performance associated with the first content item. The user request may correspond to any user input indicative of a request for voice performance or any other user performance associated with the first content item (e.g., to sing along while a song in the first content item is being played, or to give any other voice-performance (e.g., a presentation's speech, a movie's voice part, etc.) on top of an audio component of the first content item). For example, the user request corresponds to a user selection of a portion of a user interface in which the first content item is presented (e.g., the “practice” button 721 of FIG. 7, the “perform” button 723 of FIG. 7, etc.). As another example, the user request corresponds to a voice command or a user gesture.

At block 320, the processing device can receive user-generated audio content and/or user-generated video content corresponding to the user performance. For example, the processing device can receive the user-generated audio content from an audio input device (e.g., a microphone). As another example, the processing device received the user-generated video content from a video input device recording the user performance (e.g., a camera).

At block 325, the processing device can provide playback of the source content item based on the user-generated audio content and/or the user-generated video content. For example, the processing device can cause video content associated with the source content item and the user-generated video content to be presented in multiple portions of a user interface. More particularly, as illustrated in FIG. 8, the source video content and the user-generated video content can be presented in the content item players 810 and 820 of the user interface 800, respectively.

As another example, the processing device can cause audio content associated with the source content item to be played in association with the user-generated audio content. In a more particular example, the audio content associated with the source content item (e.g., audio content corresponding to instrumental music of the music item, etc.) and the user-generated audio content can be played using an audio output device at different volume levels.

At 330, the processing device can receive a user request to generate a content item corresponding to the user performance. At 335, the processing device can generate a second content item based on the user-generated audio content and/or the user-generated video content. For example, the processing device can record the user-generated video content and/or the user-generated audio content. Additionally, the processing device can mix audio content associated with the source content item with the audio signal to generate mixed audio content. The processing device then synchronizes the mixed audio content and the recorded video content to generate a content item corresponding to the user performance. Alternatively or additionally, the processing device can transmit the user-generated video content and/or the user-generated audio content to a server device for processing and/or storage. The processing device may also transmit, to the server device, a request to generate a content item corresponding to the user performance

At 340, the processing device can receive an indication to share the generated content item. The indication may correspond to any user input, such as a user selection of a “share” button 1040 of user interface 1000, a voice command, a user gesture, etc.

At block 345, the processing device transmits a request to share the generated content item to a server device (e.g., the server device 130 of FIGS. 1 and 2). The user request may include information that can be used to identify one or more other users, such as user identifiers associated with the one or more other users. The user request may also include any suitable information related to the second content item and/or the first content item, such as an identifier associated with the second content item, an identifier associated with the first content item, the user-generated audio content, the user-generated video content, etc.

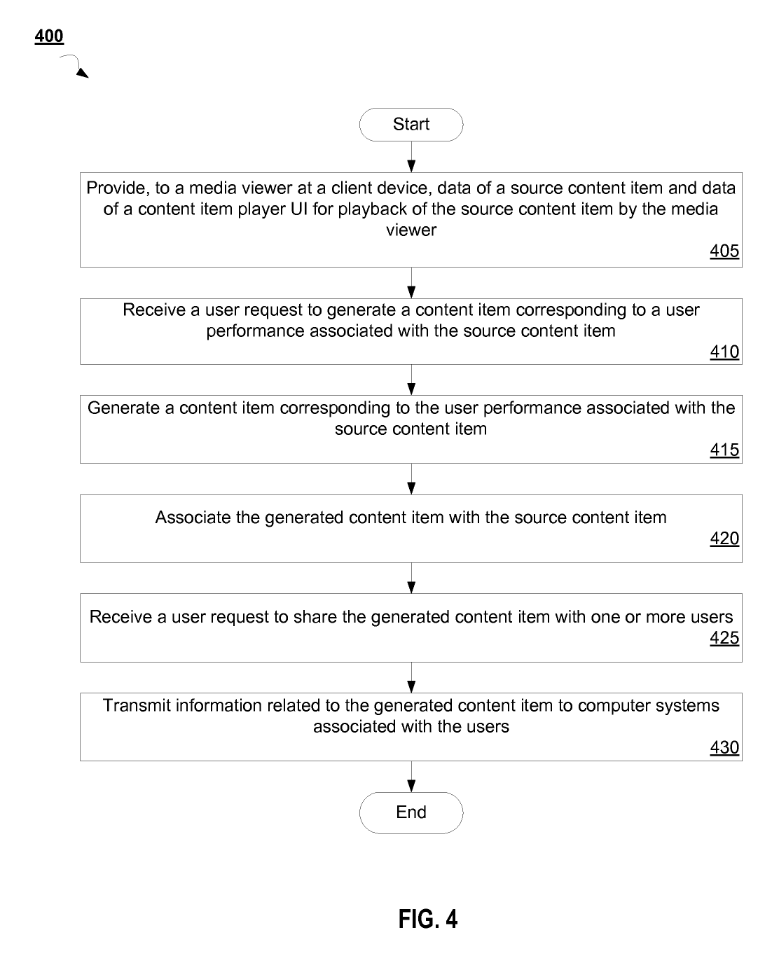

FIG. 4 is a flow diagram illustrating a method 400 for providing a content item player with voice-over on top of existing media functionality by a server device, according to some implementations of the disclosure. The method 400 may be performed by processing logic that comprises hardware (e.g., circuitry, dedicated logic, programmable logic, microcode, etc.), software (e.g., instructions run on a processing device to perform hardware simulation), or a combination thereof. In one implementation, method 400 may be performed by the server-side content item player component 140 as shown in FIGS. 1 and 2.

Method 400 begins at block 405 when the processing device provides, to a media viewer at a client device (e.g., the media viewer 111 as shown in FIGS. 1 and 2), data of a source content item and data of a content item player UI for playback of the source content item by the media viewer. The data may include video data associated with the source content item, audio data associated with the source content item, captioning data associated with the source content item, etc. In some implementations, the source content item may have one or more audio components, such as a song, a speech, a movie's voice part, etc.

At block 410, the processing device receives a user request to generate a content item corresponding to a user performance associated with the source content item. The request may include user-generated audio content, user-generated video content, timestamps associated with the user-generated audio content and/or the user-generated video content, and/or any other information for use in generation of the content item.

At block 415, the processing device generates a content item corresponding to the user performance. For example, the processing device mixes the user-generated audio content and audio content associated with the source content item to generated mixed audio content. The processing device may then synchronize the mixed audio content with the user-generated video content to generate a content item corresponding to the user performance.

At block 420, the processing device associates the generated content item with the source content item. For example, the processing device synchronizes the generated content item with the source content item. As another example, the processing device associates an identifier (e.g., a URL) with the generated content item and the source content item. The processing device may also store information related to the generated content item and the source content item in association with the identifier.

At block 425, the processing device receives a user request to share the generated content item with one or more users. At block 430, the processing device may transmit information related to the generated content item to computer systems associated with the users. For example, the processing device can send a message to client devices associated with the users. The message can include any suitable information related to the user-generated content item. The message can include a link (e.g., a URL) directed to the user-generated content item and the source content item, an image related to the second content item and/or the first content-item. The message and its associated content can be sent to the targeted users by email, text messages, mobile notifications, account notifications, etc.

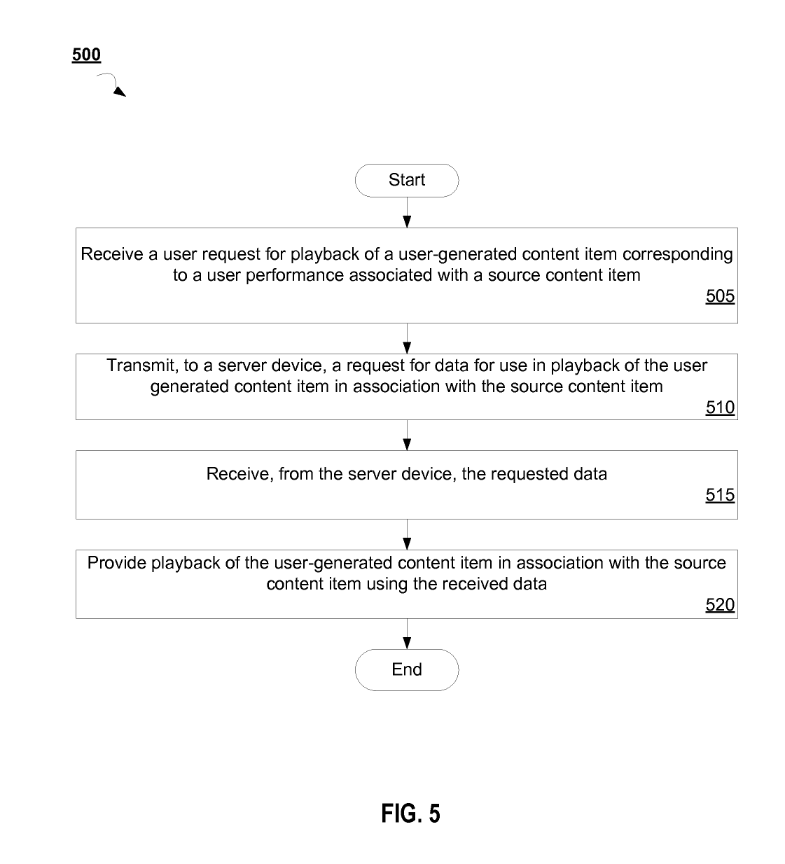

FIG. 5 is a flow diagram illustrating a method 500 for providing a content item player with voice-over on top of existing media functionality by a client device according to some implementations of the disclosure. The method 500 may be performed by processing logic that comprises hardware (e.g., circuitry, dedicated logic, programmable logic, microcode, etc.), software (e.g., instructions run on a processing device to perform hardware simulation), or a combination thereof. In one implementation, method 500 may be performed by the media viewer 111 as shown in FIGS. 1 and 2.

Method 500 begins at block 505 when the processing device receives a user request for playback of a user-generated content item corresponding to a user performance associated with a source content item. The user request may be received upon the user or any other user (e.g., a user with which the user-generated content item has been shared) selecting and/or entering a link (e.g., a URL) associated with the content item using a media viewer.

At block 510, the processing device may transmit, to a server device, a request for data for use in playback of the user generated content item in association with the source content item. At 515, the processing device may receive the requested data.

At block 520, the processing device provides playback of the user-generated content item in association with the source content item associated using the received data. The user-generated content item and the source content item may be played back as described above in connection with FIGS. 1, 2, and 7-11.

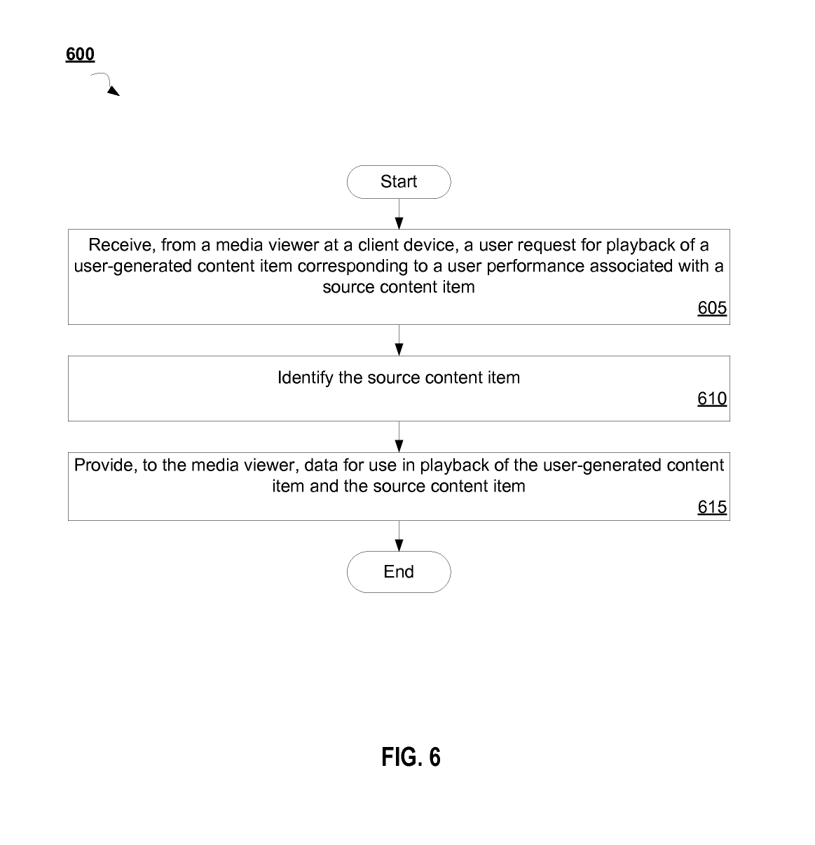

FIG. 6 is a flow diagram illustrating a method 600 for providing a content item player with voice-over on top of existing media functionality by a server device, according to some implementations of the disclosure. The method 600 may be performed by processing logic that comprises hardware (e.g., circuitry, dedicated logic, programmable logic, microcode, etc.), software (e.g., instructions run on a processing device to perform hardware simulation), or a combination thereof. In one implementation, method 600 may be performed by the server-side content item player component 140 as shown in FIGS. 1 and 2.

Method 600 begins at block 605 when the processing device receives, from a media viewer at a client device (e.g., the media viewer 111 as shown in FIGS. 1 and 2), a user request for playback of a user-generated content item corresponding to a user performance associated with a source content item. The user request may include identifying information related to the user-generated content item and/or any other suitable information related to the user-generated content item.

At block 610, the processing device identifies the source content item. The source content item may be identified using the identifying information related to the user-generated content item or any other suitable information.

At block 615, the processing device provides, to the media viewer, data for use in playback of the user-generated content item and the source content item. Additionally, the processing device may provide data of a content item player UI for playback of the user-generated content item in association with the source content item by the media viewer.

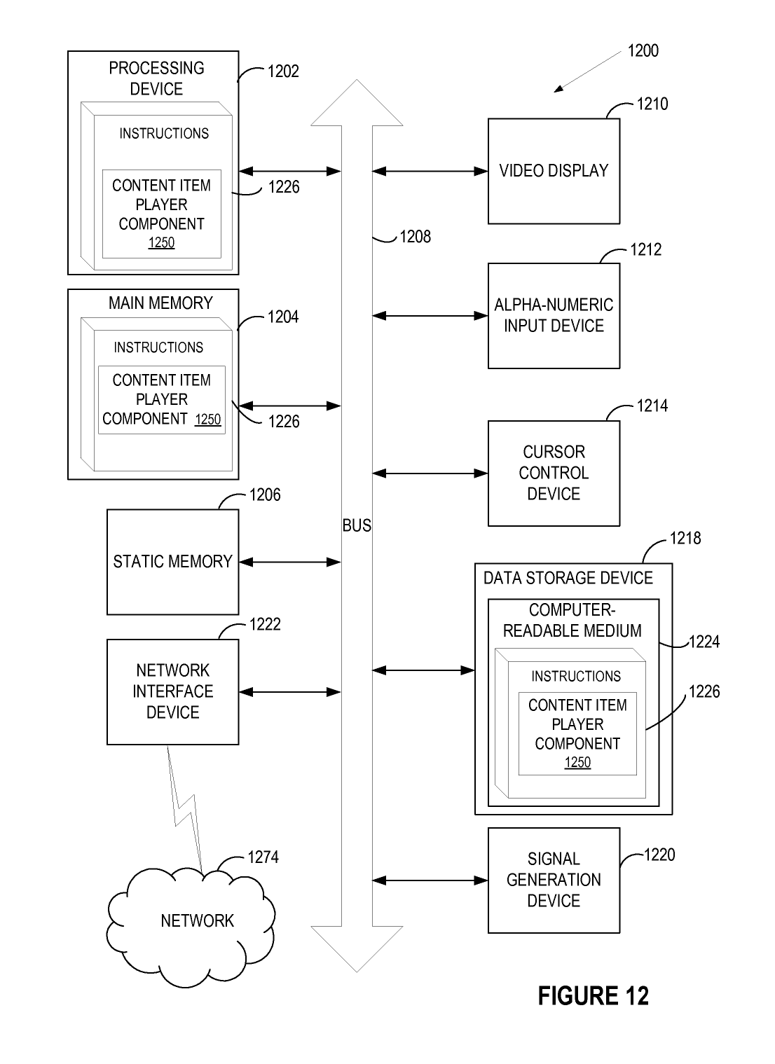

FIG. 12 illustrates a diagrammatic representation of a machine in the exemplary form of a computer system 1200 within which a set of instructions, for causing the machine to perform any one or more of the methodologies discussed herein, may be executed. In alternative implementations, the machine may be connected (e.g., networked) to other machines in a LAN, an intranet, an extranet, or the Internet. The machine may operate in the capacity of a server or a client machine in client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 1200 includes a processing device (processor) 1202, a main memory 1204 (e.g., read-only memory (ROM), flash memory, dynamic random access memory (DRAM) such as synchronous DRAM (SDRAM) or Rambus DRAM (RDRAM), etc.), a static memory 1206 (e.g., flash memory, static random access memory (SRAM), etc.), and a data storage device 1218, which communicate with each other via a bus 1208.

Processing device 1202 represents one or more general-purpose processing devices such as a microprocessor, central processing unit, or the like. More particularly, the processing device 1202 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 1202 may also be one or more special-purpose processing devices such as an application specific integrated circuit (ASIC), a field programmable gate array (FPGA), a digital signal processor (DSP), network processor, or the like. The processing device 1202 is configured to execute instructions 1226 for performing the operations and steps discussed herein.

The computer system 1200 may further include a network interface device 1222. The computer system 1200 also may include a video display unit 810 (e.g., a liquid crystal display (LCD), a cathode ray tube (CRT), or a touch screen), an alphanumeric input device 1212 (e.g., a keyboard), a cursor control device 814 (e.g., a mouse), and a signal generation device 1220 (e.g., a speaker).

The data storage device 1218 may include a computer-readable storage medium 1224 on which is stored one or more sets of instructions 1226 (e.g., software) embodying any one or more of the methodologies or functions described herein. The instructions 1226 may also reside, completely or at least partially, within the main memory 1204 and/or within the processor 1202 during execution thereof by the computer system 1200, the main memory 1204 and the processor 1202 also constituting computer-readable storage media. The instructions 1226 may further be transmitted or received over a network 1274 via the network interface device 1222.

In one embodiment, the instructions 1226 include instructions for a content item player component 850, which may correspond, respectively, to the media viewer 111 and/or the server-side content item player component 140 described with respect to FIGS. 1 and 2, and/or a software library containing methods that provide a content item player with sing-along songs functionality. While the computer-readable storage medium 1224 is shown in an exemplary implementation to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

In the foregoing description, numerous details are set forth. It will be apparent, however, to one of ordinary skill in the art having the benefit of this disclosure, that the present disclosure may be practiced without these specific details. In some instances, well-known structures and devices are shown in block diagram form, rather than in detail, in order to avoid obscuring the present disclosure.

Some portions of the detailed description have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “segmenting”, “analyzing”, “determining”, “enabling”, “identifying,” “modifying” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

The disclosure also relates to an apparatus for performing the operations herein. This apparatus may be specially constructed for the required purposes, or it may include a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such.

Reference throughout this specification to “one embodiment” or “an embodiment” means that a particular feature, structure, or characteristic described in connection with the embodiment is included in at least one embodiment. Thus, the appearances of the phrase “in one embodiment” or “in an embodiment” in various places throughout this specification are not necessarily all referring to the same embodiment. In addition, the term “or” is intended to mean an inclusive “or” rather than an exclusive “or.”

It is to be understood that the above description is intended to be illustrative, and not restrictive. Many other embodiments will be apparent to those of skill in the art upon reading and understanding the above description. The scope of the disclosure should, therefore, be determined with reference to the appended claims, along with the full scope of equivalents to which such claims are entitled.

1. A method, comprising:
providing, using a processing device, playback of a first content item using a first user interface, wherein the first content item is associated with first video content and first audio content;
receiving, using the processing device, a user request pertaining to a user performance of a user, the user performance associated with the first content item;
generating second video content and second audio content in response to receiving the user request, wherein the second video content and the second audio content correspond to the user performance during playback of the first content item;
providing, using the processing device, playback of the first content item in synchronization with the second video content and the second audio content that were generated during the playback of the first content item by providing a display of the first content item while the second video content and the second audio content are provided, and wherein the second video content and the second audio content are provided at a content item player that previously provided the playback of the first content item during the user performance;
identifying one or more other users that are connected to the user on a social network; and
providing, at the first user interface and in response to the generating of the second video content and the second audio content, a message identifying the one or more other users that are connected to the user on the social network, wherein the second video content and the second audio content that correspond to the user performance are shared with the one or more other users in response to a selection of the identification of the one or more other users in the message.

2. The method of claim 1, wherein providing playback of the first content item in synchronization with the second video content and the second audio content comprises:
causing the first video content to be presented in a first portion of a second user interface; and
causing the second video content to be presented in a second portion of the second user interface.

3. The method of claim 1, wherein providing playback of the first content item in synchronization with the second video content and the second audio content comprises causing the second audio content to be played in association with the first audio content.

4. The method of claim 1, further comprising:
generating a second content item by recording the second audio content and the second video content.

5. The method of claim 4, further comprising:
receiving a user request to share the second content item with a contact of the user in response to a selection of an identification of the contact in the first user interface; and
causing information related to the second content item to be sent to a computer device associated with the contact of the user.

6. The method of claim 4, further comprising:
receiving a user request for playback of the second content item;
causing the first video content to be presented in a first portion of a third user interface;
causing the second video content to be presented in a second portion of the third user interface, wherein the first video content is presented in synchronization with the second video content; and
causing the first audio content to be played in synchronization with the second audio content.

7. The method of claim 6, further comprising:
receiving a user request to switch from the first content item to the second content item;
causing the first video content to be presented in the second portion of the third user interface; and
causing the second video content to be presented in the first portion of the third user interface.

8. The method of claim 6, further comprising:
receiving a first indication to dismiss the first portion of the third user interface; and
dismissing the playback of the first audio content in response to receiving the first indication.

9. The method of claim 6, further comprising:
receiving a second indication to dismiss the second portion of the third user interface; and
dismissing the playback of the second audio content in response in response to receiving the second indication.

10. An apparatus, comprising:
a memory; and
a processing device communicably coupled to the memory, the processing device to execute instructions to:
provide playback of a first content item using a first user interface, wherein the first content item is associated with first video content and first audio content;
receive a user request pertaining to a user performance of a user, the user performance associated with the first content item;
generate second video content and second audio content in response to receiving the user request associated with the first content item, wherein the second video content and the second audio content correspond to the user performance during playback of the first content item;
provide playback of the first content item in synchronization with the second video content and the second audio content that were generated during the playback of the first content item by providing a display of the first content item while the second video content and the second audio content are provided, and wherein the second video content and the second audio content are provided at a content item player that previously provided the playback of the first content item during the user performance;
identify one or more other users that are connected to the user on a social network; and
provide, at the first user interface and in response to the generating of the second video content and the second audio content, a message identifying the one or more other users that are connected to the user on the social network, wherein the second video content and the second audio content that correspond to the user performance are shared with the one or more other users in response to a selection of the identification of the one or more other users in the message.

11. The apparatus of claim 10, wherein, to provide playback of the first content item in synchronization with the second video content and the second audio content, the processing device is further to:
cause the first video content to be presented in a first portion of a second user interface; and
cause the second video content to be presented in a second portion of the second user interface.

12. The apparatus of claim 10, wherein to provide playback of the first content item in synchronization with the second video content and the second audio content, the processing device is further to cause the second audio content to be played in association with the first audio content.

13. The apparatus of claim 10, wherein the processing device is further to:
generate a second content item based on the second video content and the second audio content.

14. The apparatus of claim 13, wherein the processing device is further to:
receive a user request to share the second content item with a contact of the user in response to a selection of an identification of the contact in the first user interface; and
cause information related to the second content item to be sent to a computer device associated with the contact of the user.

15. The apparatus of claim 13, wherein the processing device is further to:
receive a user request for playback of the second content item;
cause the first video content to be presented in a first portion of a third user interface;
cause the second video content to be presented in a second portion of the third user interface, wherein the first video content is presented in synchronization with the second video content; and
cause the first audio content to be played in synchronization with the second audio content.

16. A non-transitory machine-readable storage medium storing instructions which, when executed, cause a processing device to:
provide playback of a first content item using a first user interface, wherein the first content item is associated with first video content and first audio content;
receive a user request pertaining to a user performance of a user, the user performance associated with the first content item;
generate, by the processing device, second video content and second audio content in response to receiving the user request associated with the first content item, wherein the second video content and the second audio content correspond to the user performance during playback of the first content item;
provide playback of the first content item in synchronization with the second video content and the second audio content that were generated during the playback of the first content item by providing a display of the first content item while the second video content and the second audio content are provided, and wherein the second video content and the second audio content are provided at a content item player that previously provided the playback of the first content item during the user performance;
identify one or more other users that are connected to the user on a social network; and
provide, at the first user interface and in response to the generating of the second video content and the second audio content, a message identifying the one or more other users that are connected to the user on the social network, wherein the second video content and the second audio content that correspond to the user performance are shared with the one or more other users in response to a selection of the identification of the one or more other users in the message.

17. The non-transitory machine-readable storage medium of claim 16, wherein, to provide playback of the first content item in synchronization with the second video content and the second audio content, the processing device is further to:
cause the first video content to be presented in a first portion of a second user interface; and
cause the second video content to be presented in a second portion of the second user interface.

18. The non-transitory machine-readable storage medium of claim 16, wherein, to provide playback of the first content item in synchronization with the second video content and the second audio content, the processing device is further to cause the second audio content to be played in association with the first audio content.

19. The non-transitory machine-readable storage medium of claim 16, wherein the processing device is further to:
generate a second content item based on the second video content and the second audio content.

20. The non-transitory machine-readable storage medium of claim 19, wherein the processing device is further to:
receive a user request for playback of the second content item;
cause the first video content to be presented in a first portion of a third user interface;
cause the second video content to be presented in a second portion of the third user interface, wherein the first video content is presented in synchronization with the second video content; and
cause the first audio content to be played in synchronization with the second audio content.
